(19) United States
(12) Patent Application Publication
(10) Pub. No.: US 2016/0239675 A1
(43) Pub. Date: Aug. 18, 2016

(54) SYSTEM AND METHOD FOR PERMISSION BASED DIGITAL CONTENT SYNDICATION, MONETIZATION, AND LICENSING WITH ACCESS CONTROL BY THE COPYRIGHT HOLDER

(71) Applicants: Joshua D. Tobkin, San Francisco, CA (US); Gjergj Sinishtaj, Sterling Heights, MI (US)

(72) Inventors: Joshua D. Tobkin, San Francisco, CA (US); Gjergj Sinishtaj, Sterling Heights, MI (US)

(21) Appl. No.: 15/046,396

(22) Filed: Feb. 17, 2016

Related U.S. Application Data
(60) Provisional application No. 62/117,250, filed on Feb. 17, 2015.

(51) Int. Cl. G06F 21/62; G06Q 30/06

(52) U.S. Cl. CPC G06F 21/6218; G06Q 30/0609

(57) ABSTRACT

A system for controlling access to digital content enables global sharing of digital content under terms negotiated between a content owner and a content subscriber, facilitates commerce and the sale of digital access to any digitally transmittable data. The system may include preconfigured online forms in which users simply “fill in the blanks” to create legally binding contracts and/or licenses, including full terms of agreement, date filed, license key, and other identifying information. The system permits monitoring of content deployment by the subscriber for compliance with agreement terms such as: where content may be published and viewed, duration, age limit, by the pageview, and other customizable terms between the parties. The system provides a two-way marketplace that facilitates the finding of content, the setting of agreement terms, and a content collaboration tool. Analytics are provided and the platform facilitates monetary transactions in a trusted centralized location.

### CROSS REFERENCE TO RELATED APPLICATION

This application claims benefit of U.S. provisional patent application Ser. No. 62/117,250, filed Feb. 17, 2015, which application is incorporated herein in its entirety.

### BACKGROUND

1. Technical Field

The present disclosure relates generally to digital rights management. More particularly, the present disclosure relates to a method and system for permission-based digital content syndication, monetization, and licensing with access control by the copyright holder.

2. Background Information

The Information Age has created a deluge of digital content which is readily accessed by information consumers via publicly-available networks such as the Internet. It is a great challenge to prevent the misappropriation of digital content. Even though such content is protected by copyright laws, it is nearly impossible to monitor the Internet for violations. And catching perpetrators is very difficult. It is the goal of Digital Rights Management (DRM) technology to prevent theft of content at the outset, hopefully eliminating the need for policing networks and apprehending pirates after the fact.

The digital revolution that has empowered consumers to use digital content in new and innovative ways has also made it nearly impossible for copyright holders to control the distribution of their property.

Publishers are under great pressure to keep their audiences engaged because the Internet audience has come to expect quality content and a generally superior experience. Additionally, quality content is expensive to produce. It is also sometimes difficult for a publisher to secure permission to use copyrighted content from the copyright holder. Thus, market conditions actually encourage the misuse of copyrighted content, with the result that pirating and theft of copyrighted content have become extremely common and are extremely difficult to prevent.

The main problem that occurs with digital content in the syndication, distribution, compensation, and permission-granting process is that the process is disparate, unsynchronized and cumbersome, having little automation.

Syndication of content must be done with the copyright holder's permission. However, in order to receive this permission, it is required to figure out a way to contact the copyright holder. There is no telling if the copyright holder is even interested in having their content syndicated. This takes time to research how to contact the copyright holder and also time for the copyright holder to grant or refuse permission.

If permission is granted, distribution of the content is another major issue. Currently the process requires copyright holders to manually provide republisher/content subscribers/subscribers the content in a digital format for reprint. The conventional practice is to transmit, often via email, the code and content to be republished. Discussions about how the content may need to be altered to fit the republisher/content subscriber's request may require several communication touch points.

If a copyright holder would like to update the content that has been reprinted, he or she must contact each republisher/content subscriber by email or otherwise communicate the content that needs to be updated, and then someone must manually make those adjustments by logging into their platform, making the adjustments to the content, updating the content and pushing the changes live.

### SUMMARY

A system for controlling access to digital content enables global sharing of digital content under terms negotiated between a content owner and a content subscriber, facilitates commerce and the sale of digital access to any digitally transmittable data. The system may include preconfigured online forms in which users simply “fill in the blanks” to create legally binding contracts and/or licenses, including full terms of agreement, date filed, license key, and other identifying information. The system permits monitoring of content deployment by the subscriber for compliance with agreement terms such as: where content may be published and viewed, duration, age limit, by the pageview, and other customizable terms between the parties. The system provides a two-way marketplace that facilitates the finding of content, the setting of agreement terms, and a content collaboration tool. Analytics are provided and the platform facilitates monetary transactions in a trusted centralized location.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram of an exemplary network architecture in which a system for permission-based digital content syndication, monetization and licensing with access control by the copyright holder may be implemented;

FIG. 2 is a block diagram of a computer system suitable for implementing a system for permission-based digital content syndication, monetization and licensing with access control by the copyright holder;

FIG. 3 provides a diagram of a system architecture for permission-based digital content syndication, monetization and licensing with access control by the copyright holder;

FIG. 4 provides a block diagram of an application architecture in a system for permission-based digital content syndication, monetization and licensing with access control by the copyright holder;

FIG. 5 provides a data flow diagram in a system for syndication, monetization and licensing with access control by the copyright holder;

FIG. 6 provides a flow diagram of a process embodied in a module for listing content;

FIG. 7 provides a flow diagram of a process embodied in a module for checking content originality;

FIG. 8 provides a flow diagram of a process embodied in a module admin/editor approval;

FIG. 9 provides a flow diagram of a process embodied in a content-searching module;

FIG. 10 provides a flow diagram of a process embodied in a social coefficient discovery module;

FIG. 11 provides a flow diagram of a process embodied in a demand-based content pricing module;

FIG. 12 provides a flow diagram of a process embodied in a permission communication negotiation module;

FIG. 13 provides a flow diagram of a process embodied in a permission script generation and code-execution module;

FIG. 14 provides a flow diagram of a process embodied in a first collaboration-editing and -versioning module;

FIG. 15 provides a flow diagram of a process embodied in a second collaboration-editing and -versioning module;

FIG. 16 provides a flow diagram of a process embodied in a content updating module;

FIG. 17 provides a flow diagram of a process embodied in an analytics module;

FIG. 18 provides a flow diagram of a process embodied in a payment calculation module;

FIG. 19 provides a flow diagram of a process embodied in a time-on-site pricing module;

FIG. 20 provides a flow diagram of a process embodied in an amount-consumed pricing module;

FIG. 21 provides a flow diagram of a process embodied in an access control module for non-website devices; and

FIG. 22 provides a flow diagram of a process embodied in a multi-code execution module.

### DETAILED DESCRIPTION

A system for controlling access to digital content enables global sharing of digital content under terms negotiated between a content owner and a content subscriber, facilitates commerce and the sale of digital access to any digitally transmittable data. The system may include preconfigured online forms in which users simply “fill in the blanks” to create legally binding contracts and/or licenses, including full terms of agreement, date filed, license key, and other identifying information. The system permits monitoring of content deployment by the subscriber for compliance with agreement terms such as: where content may be published and viewed, duration, age limit, by the pageview, and other customizable terms between the parties. The system provides an interactive marketplace that facilitates the finding of content, the setting of agreement terms, and a content collaboration tool. Analytics are provided and the platform facilitates monetary transactions in a trusted centralized location.

Thus, a copyright holder may have a profile and a means to list his/her content in a marketplace setting. The permission and licensing process is streamlined so that content permission requests can occur much more quickly. Furthermore, the copyright holder is readily available to be asked permission to reprint their content since he/she is participating on the system. If a permission request occurs, the copyright holder may receive a notification of the request and can manage incoming requests through a central location.

The system allows content creators to list their content once on the system and that piece of content, or variations of it, can be distributed and managed with permission from a central location. If edits need to be made, the copyright holder can create a version of the original, make updates, and provide that version to the specified republisher/content subscribers. Instead of having to manage each reprint on a manual case-by-case basis, this system centralizes these communications and allows the content to be distributed in a controlled manner.

Technologically there has not been a bridging of these business and legal needs to create a streamlined solution for copyright holders until our creation. The presently described system and method provides a technological solution to unify disparate syndication, distribution, compensation, and permission granting processes required to provide the copyright holder control over how their content is utilized. Without a solution like ours, it is much more time and resource intensive to enforce creator's rights over his/her copyrighted digital material because several disjointed steps are normally required to facilitate these transactions.

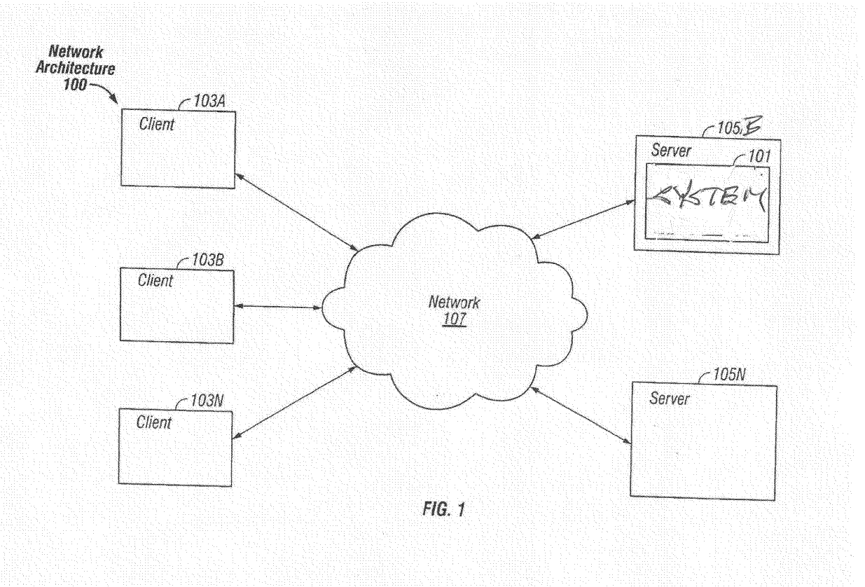

FIG. 1 is a block diagram illustrating an exemplary network architecture 100 in which the system 101 may be implemented. The illustrated network architecture 100 comprises multiple clients 103A, 103B and 103N, as well as multiple servers 105A and 105N. In FIG. 1, the system 101 is illustrated as residing on server 105A. It is to be understood that this is an example only, and in various embodiments various functionalities of this system 101 may be instantiated on a server 105, a client 103, or may be distributed between multiple clients 103 and/or servers 105.

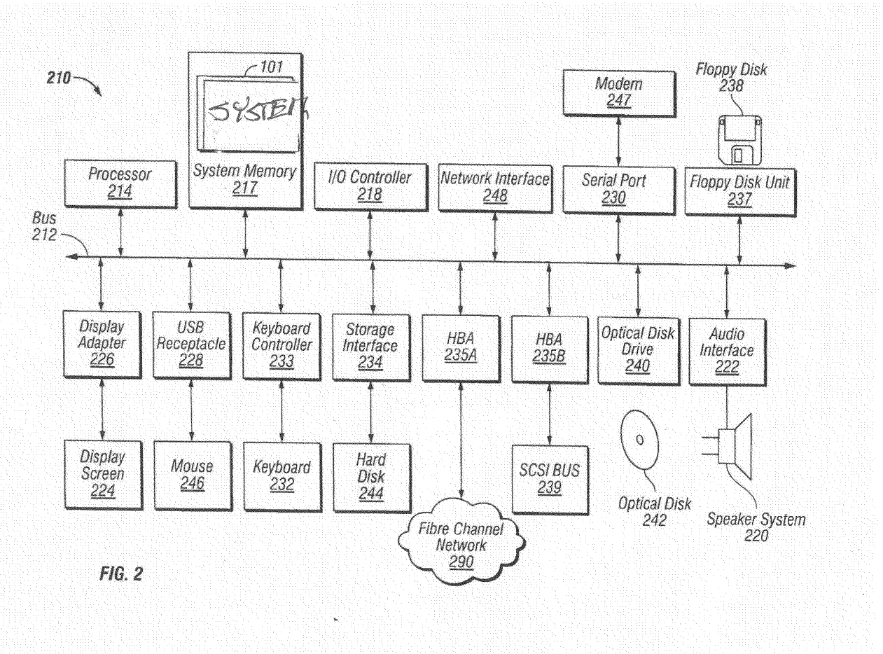

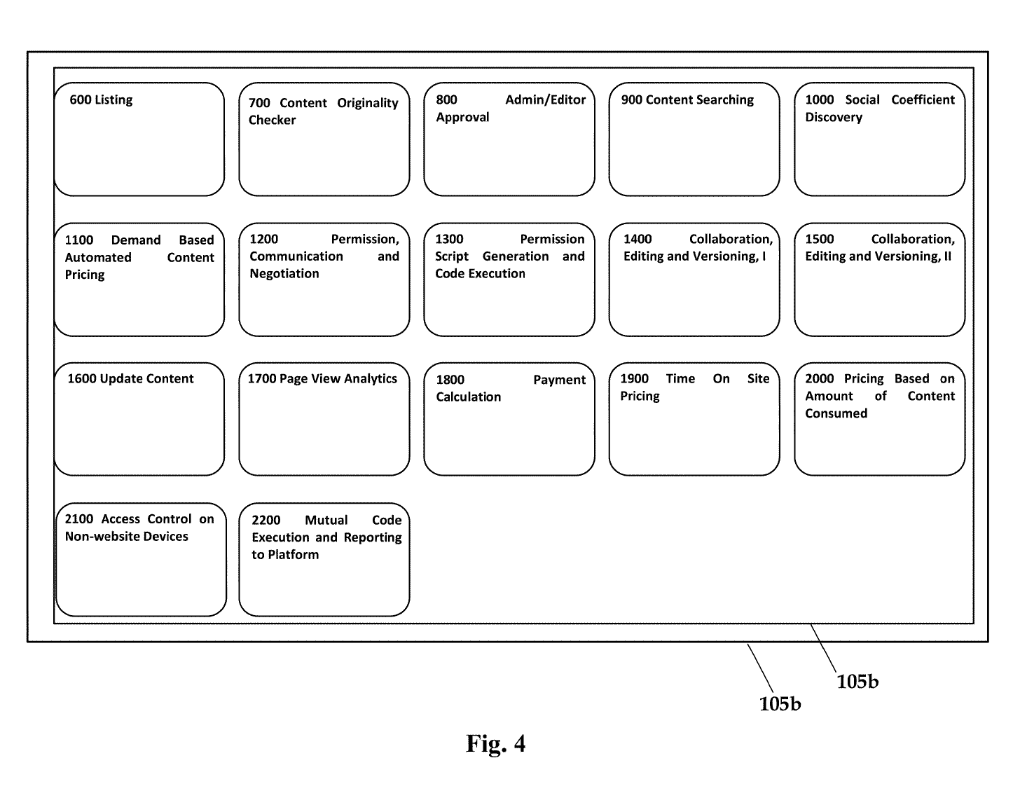

Clients 103 and servers 105 may be implemented using computer systems 210 such as the one illustrated in FIG. 2 and described below. The clients 103 and servers 105 may be communicatively coupled to a network 107, for example, via a network interface 248 or modem 247 as described below in conjunction with FIG. 2. Clients 103 are able to access applications and/or data on servers 105 using, for example, a web browser or other client software (as shown in FIG. 4). Clients 103 may, but need not, be in the form of mobile computing devices, comprising portable computer systems 210 capable of connecting to a network 107 and running applications. Such mobile computing devices are sometimes referred to as smartphones, although many mobile phones not so designated also have these capabilities. Tablet computers are another example of mobile computing devices.

Although FIG. 1 illustrates three clients 103 and two servers 105 as an example, in practice many more (or fewer) clients 103 and/or servers 105 may be deployed. In one embodiment, the network 107 may be in the form of the Internet. Other networks 107 or network-based environments may be used in other embodiments.

FIG. 2 is a block diagram of a computer system 210 suitable for implementing the system 101. FIG. 1 is a block diagram illustrating an exemplary network architecture 100 in which the system 101 may be implemented. The illustrated network architecture 100 comprises multiple clients 103A, 103B and 103N, as well as multiple servers 105A and 105N. In FIG. 1, the system 101 is illustrated as residing on server 105A. It is to be understood that this is an example only, and in various embodiments various functionalities of this system 101 may be instantiated on a server 105, a client 103, or may be distributed between multiple clients 103 and/or servers 105.

Clients 103 and servers 105 may be implemented using computer systems 210 such as the one illustrated in FIG. 2 and described below. The clients 103 and servers 105 may be communicatively coupled to a network 107, for example via a network interface 248 or modem 247 as described below in conjunction with FIG. 2. Clients 103 are able to access applications and/or data on servers 105 using, for example, a web browser or other client software. Clients 103 may, but need not, be in the form of mobile computing devices, comprising portable computer systems 210 capable of connecting to a network 107 and running applications. Such mobile computing devices are sometimes referred to as smartphones, although many mobile phones not so designated also have these capabilities. Tablet computers are another example of mobile computing devices.

Although FIG. 1 illustrates three clients 103 and two servers 105 as an example, in practice many more (or fewer) clients 103 and/or servers 105 may be deployed. In one embodiment, the network 107 may be in the form of the Internet. Other networks 107 or network-based environments may be used in other embodiments.

FIG. 2 is a block diagram of a computer system 210 suitable for implementing the system 101. Both clients 103 and servers 105 may be implemented in the form of such computer systems 210. As illustrated, one component of the computer system 210 may be a bus 212. The bus 212 may communicatively couple other components of the computer system 210, such as at least one processor 214, system memory 217 (such as random access memory (RAM), read-only memory (ROM), flash memory), an input/output (I/O) controller 218, an audio output interface 222 communicatively coupled to an external audio device such as a speaker system 220, a display adapter 226 communicatively coupled to an external video output device such as a display screen 224, one or more interfaces such as serial ports 230, Universal Serial Bus (USB) receptacles 230, parallel ports (not illustrated), etc., a keyboard controller 233 communicatively coupled to a keyboard 232, a storage interface 234 communicatively coupled to at least one hard disk 244 (or other form(s) of magnetic media), a floppy disk drive 237 configured to receive a floppy disk 238, a host bus adapter (HBA) interface card 235A configured to connect with a Fibre Channel (FC) network 290, an HBA interface card 235B configured to connect to a SCSI bus 239, an optical disk drive 240 configured to receive an optical disk 242, a mouse 246 (or other pointing device) coupled to the bus 212 e.g., via a USB receptacle 228, a modem 247 coupled to bus 212, e.g., via a serial port 230, and a network interface 248 coupled, e.g., directly to bus 212.

Other components (not illustrated) may be connected in a similar manner (for example, document scanners, digital cameras, printers, etc.). Conversely, all of the components illustrated in FIG. 2 need not be present. The components may be interconnected in different ways from that shown in FIG. 2.

The bus 212 allows data communication between the processor 214 and system memory 217, which, as noted above may include ROM and/or flash memory as well as RAM. The RAM is typically the main memory into which the operating system and application programs are loaded. The ROM and/or flash memory may contain, among other code, the Basic Input-Output system (BIOS) which controls certain basic hardware operations. Application programs may be stored on a local computer readable medium (e.g., hard disk 244, optical disk 242) and loaded into system memory 217 and executed by the processor 214. Application programs may also be loaded into system memory 217 from a remote location (i.e., a remotely located computer system 210), for example via the network interface 248 or modem 247. In FIG. 2, the system 101 is illustrated as residing in system memory 217. The workings of the system 101 are explained in greater detail below in conjunction with the remaining Figures.

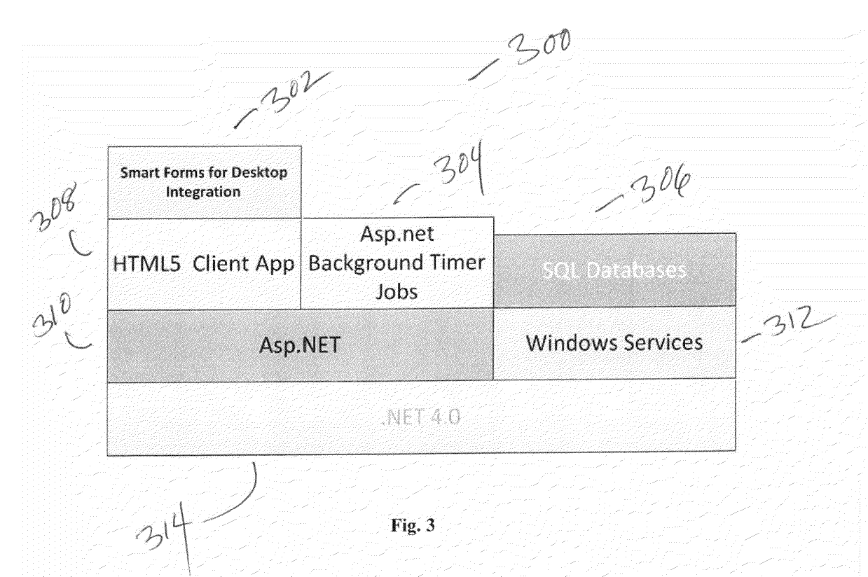

FIG. 3 provides a diagram of an exemplary architecture 300 upon which the system 101 may be implemented. In brief, the architecture 300 may include one or more of the following components:
.NET 4.0 (314)—The .NET framework is a development platform, which runs primarily on WINDOWS (Microsoft Corp, Redmond, Wash.), providing generic functionality that can be selectively modified using additional user-written code, to provide application-specific software;
Asp.NET (310)—Asp.NET is an open source server-side Web application framework designed for Web development to produce dynamic web pages. Asp.NET web pages, known conventionally as web forms, serve as the main building blocks for application development,
Windows services (312)—WINDOWS services are applications that run as background processes which usually have limited interaction with customary I/O and may be launched by the operating system (OS) at boot time. In more recent versions of WINDOWS, WINDOWS services can be configured and manually started and stopped through the Control Panel. An example of a WINDOWS service may be, for example, an application that writes data to an event log, a database server, an anti-virus engine, etc.
HTML5 client app (308)—client-side application written in HTML5 (hypertext markup language);
Asp.NET:Background Timer:Jobs (304)—There are situations wherein an application needs to execute code on a recurring basis, for example, to create a report, to send a reminder e-mail, to back up data, and so on. It is with a timer that these recurring tasks are scheduled and run according to the schedule;
SQL Databases (306)—databases that support the use of SQL to access their data. As described herein below, the system for policy-based confidentiality management includes at least a policy database. In addition, each of the systems with which the system interacts, for example the practice management system or the document management system includes at least one database; and
Smart Forms for desktop integration (302)—Smart Forms are electronic forms that have certain capabilities built into them, for example, performing calculations, displaying dynamic content, validating data and looking up data from remote systems.

The foregoing architecture is described only as an example. One of ordinary skill will readily understand that there may exist many possible combinations of many alternative building blocks to produce a system having the same or similar functional capabilities.

FIG. 4 provides a block diagram of an application architecture 400 in the system 101. In embodiments, the system 101 may include modules for at least one of:
Content listing (600);
Content originality checking (700);
Administrative/editor approval (800);
Content searching (900);
Social coefficient discovery (1000);
Demand-based automated content pricing (1100);
Permission, communication and negotiation (1200);
Permission script generation and code execution (1300);
Collaboration, editing and versioning I (1400);
Collaboration, editing and versioning II (1500);
Update content (1600);
Pageview analytics (1700);
Payment calculation (1800),
Time-on-site pricing (1900);
Pricing based on amount of content consumed (2000);
Access control on non-website devices (2100); and
Mutual code execution and reporting to platform (2200).

Referring now to FIG. 5, shown is a data flow diagram in a system 101 for permission based digital content syndication, monetization, and licensing with access control by the copyright holder.

In embodiments, the system 101 may include at least one cloud server 105b. As previously described, the cloud server may include data storage and one or more processors. In embodiments, residing in memory on the cloud server 105b is an application 400 that may include a number of modules 600-2200. In embodiments, the modules may include a plurality of routines and/or sub-routines, execution of which by the processor on the cloud server results in the various functionalities attributed herein below to the modules 600-2200.

In embodiments, various items of digital content may reside on a content server 105a. In embodiments, the digital content may be owned by one or more copyright holders and is therefore subject under various statutory and common-law schemes to copyright protection. Thus the copyright holder is entitled to regulate the use of the content by others, including specifying when and where and by whom copies of the content may be made and how much the copyright holder is to be compensated for allowing use of its owned content.

In embodiments, the cloud server may be controlled by the third party, with whom the copyright holder has entered into an agreement to distribute the copyright holder's owned content under conditions negotiated between the copyright holder and a party desiring to republish the owned content. Thus, in embodiments, the copyright holder may submit digital content 600 to the cloud server 105b for distribution by the third party. In embodiments, the submission of the content may include either of:
direct submission of content to the third party, whereupon the submitted digital content may be housed on the cloud server 105b and distributed therefrom; and
identifying the content on the content server 105a by enclosing the content within a plurality of content tags provided by the third party 800.

In embodiments, submission may be done primarily through verification tags, which may be HTML ‘div’ tags that are wrapped around the content to be listed on the platform. Furthermore, content can be directly uploaded and listed onto the system 101.

When the tags are posted, the copyright holder may notify the third party that they are in place, which signals the third party to visit the webpage in question, search for the identification tags, and save a copy of the contents within the tags on the cloud server 105b, which can be reviewed, refreshed, and altered by the original submitter (and by others with the permission of the copyright holder). Then it is saved and listed on the server 105b.

In embodiments, prior to listing the content, the third party may scan the content for duplications within the system 101. In embodiments, the duplicate-content detection may be done by scanning the content sentence by sentence. If the content exceeds a threshold value for similarity to other content on the system 101, it may be deemed the same as the other content on the system and it may not be listed. In embodiments, the threshold may be determined by a site administrator.

In the event that content is directly uploaded, the verification and uniqueness-checking step may be eliminated. In embodiments, the system may provide a dispute—resolution mechanism that allows an original content creator to initiate a dispute to claim ownership of particular content. In embodiments, copyright violators may be penalized.

A prospective content republisher/content subscriber can search the server/database 105b for content in which they may be interested. If he/she finds something he/she likes, he/she may have the ability to reach out to the original copyright owner through the system to ask for permission to reprint the content 501.

Through the system 101, a communication bridge 500 is created that allows for terms to be negotiated, wherein the copyright owner can control display of his/her content for example: where; for how long, under what terms, as long as the terms can be implemented and monitored by a computing system 101. This may also provide the original copyright owner the ability to terminate the relationship, as well.

If terms are agreed and permission is granted, the server 105b may produce unique HTML and JavaScript script (“Mutual-Code”), which will execute the terms specified in the license agreement (1300). In an embodiment, the rules may be organized in a JavaScript object Notation (JSON) format.

The republisher/content subscriber may then install the script on the republisher/content subscriber site or device, which will ping the server 105b to cross-reference permission settings 502, and then the server delivers the content by “printing” or “injecting” the content into a page on the republisher/content subscriber's site/device, while inheriting the styles of the republisher/content subscriber's site/device. This, thereby, makes the content appear to be native, as if the content was originally published on the republisher/content subscriber's site/device 105c.

The system 101 thus allows for content to be shared globally, digitally, with permission, by terms agreed upon by the original copyright owner and the re-publisher (subscriber), among several other things which will be listed here below in more detail:
enables permission-based content sharing in a way that permits the copyright holder to set the terms of the agreement and, if necessary, negotiate with the potential licensee;
rapid copyright licensing and the optional use of preconfigured “Natural Language Form Agreements,” which is an online form in which the user simply “fills in the blanks” to create a legally binding contract or license—with full terms of agreement, date filed, license key, and other identifying information. Furthermore, the system 101 facilitates agreements that deal with geo-political copyright terms, or simply to the discretion of the copyright holder. The “Natural Language Form Agreement” form is an optional service. The system can facilitate virtually any digital licensing agreement that can be operated by a computing device;
it permits monitoring where content is allowed to be published and viewed, including the duration, geographical limitations, age limit, by the pageview, and other various customizable terms between the parties involved, including time-on-site billing capabilities;
it facilitates commerce and the sale of digital access to digital content (any digitally transmittable data). ContentMutual.com, which is the main name of the original system 101 where this technological process resides, provides an interactive marketplace that facilitates the finding of content, the setting of agreement terms, and a content collaboration tool. Furthermore, analytics which are garnered through the facilitation of content delivery and access-control are provided so that the system and process enable the facilitation of monetary transactions based on those analytics in a trusted centralized location;
it allows for global publishing on a pay-per-pageviews basis, fixed costs, or virtually any negotiated terms that can be implemented and monitored by a computer. All terms can be handled through customizable contracts or agreed terms, as long as they are abiding within global legal boundaries. The Mutual-Code, which is a mixture of HTML/CSS and JavaScript, executes the terms negotiated;
it facilitates cross-licensing of content—so, for example, if an article is listed to the system 101 and it contains an image that is being paid for on a pay-per-pageview model from the system 101, rights can be passed along to any publisher who wants to republish the newly listed article, which contains content that ordinarily requires further licensing, in order to be fully compliant. The system can track licenses within licenses;
based on demand, the system enables dynamic pricing, in which will the price is increased incrementally based on the negotiated threshold set forth by the rights holder and system admins;
term renewal and copyright license settings and licensees can be managed easily through the system, making it easy to stay organized;
the system 101 can measure pageviews to produce meaningful analytics on a per content-piece basis;
the system 101 is able to crawl” and scan and “scrape-content-with-permission” by requiring the original content owner to wrap the content they want listed on the server 105b with unique HTML identification tags, and to tell the system 101 to make a copy of the content contained within the tags and save it to a content repository. The act of adding code to the original source code represents a verification method and expression of compliance and intention to be indexed, tracked, and stored in our system. If a copyright holder uploads content directly to the system, a dispute system is enabled that initiates an investigation into any copyright claims;
the system 101 may generate a script that injects or writes web code or data into an HTML document or de after running a series of customizable permission settings, such as:
   is this article allowed to be shown on this URL;
   is the person viewing this content from an IP address that is not permitted;
   has the expiration date on this license or contract passed;
   is there a variation of the original content that is designated to display here;
   in what manner should this content be displayed; and
   should the system also inject any other content (with the permission of the copyright owner and the content republisher/content subscriber or consumer);
the system 101 provides a process for validating the identity of the content owner based on their ability to access the source code of their original post;
re-scan content on a periodical basis to keep content updated with permission;
facilitates creative ways to find content, by searching unique parameters such as by profession, by country original content originated or was initially published, content writing/narrative style, by industry, and by the content's “Social Coefficient,” which is the total number of social—shares relative to the total number of pageviews or requests (and other metrics explained further below) to display;
these factors apply to all forms of digital content—including video, audio, articles or text, images and even virtual reality video content;
the system 101 is able to see the user's IP address, User agent, referrer URL, cookies of the site, and more, and can make decisions based on that data as per stipulated in the licensing agreements that are formed during negotiations; and
track the activity of users interacting with content that is being “printed” by our script to measure amount of content consumed, duration on site, how much content was scrolled through.

### Application Modules

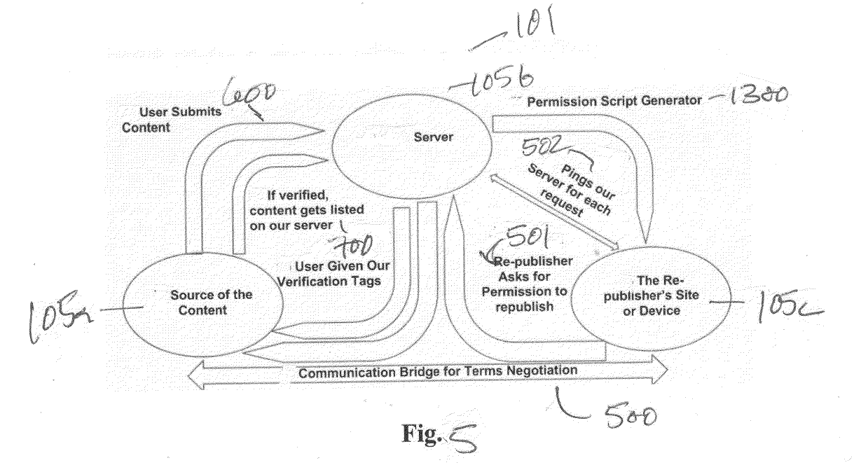

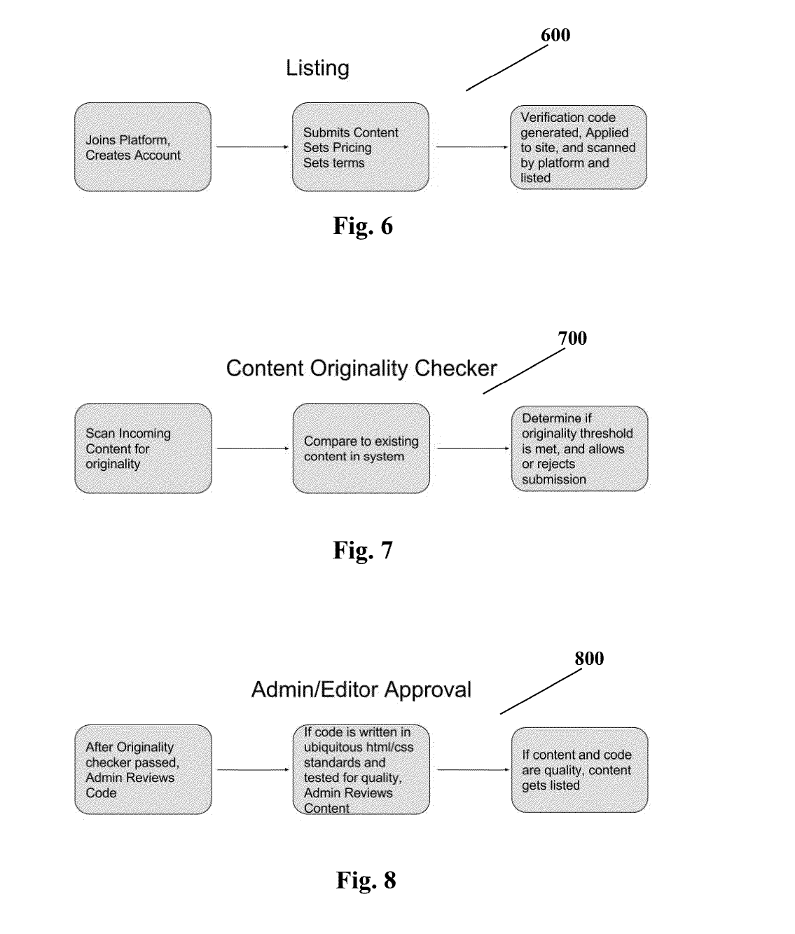

FIG. 6 provides a flow diagram of a process embodied in a module for listing content 600.

A copyright holder creates an account, then navigates to ‘Submit Content.’ There he/she may select the type of content. If the content is video, virtual reality video, or audio content, the copyright holder will be asked to upload the content.

If it is text based content, like an article, he/she may be asked to fill out details of the to-be listed content, such as headline, category, profile image, description and the exact URL where the content exists. This is also where the initial pricing and limitation terms are articulated by the copyright holder.

During the next step, a unique verification ID is generated. In embodiments, this verification ID may be an HTML element that allows the system 101 to determine where the to-be-listed content begins and ends. After the verification tags have been placed and saved on the website where the content originally resides, the copyright holder directs the system 101 to visit the website, scan and make a copy of the content within the verification tags.

FIG. 7 provides a flow diagram of a process embodied in a module for checking content originality 700.

To ensure the quality of the content, the system 101 may scan incoming content against content that already exists within the system 101 and its content repository. The system 101 may scan each sentence, one by one, looking for duplicates. The system 101 may calculate the amount of duplicate content versus the total volume of the article to determine a uniqueness threshold, which is configurable by a system administrator. If the system finds that the amount of duplicate content exceeds the uniqueness threshold the content may not be listed on the system 10. In such case, the system 101 may deliver notification to the poster that his/her submission has been rejected.

FIG. 8 provides a flow diagram of a process embodied in a module for admin/editor approval 800. After content uniqueness has been established, the article may be pending until an admin or editor reviews the content, for example, for proper HTML/CSS formatting.

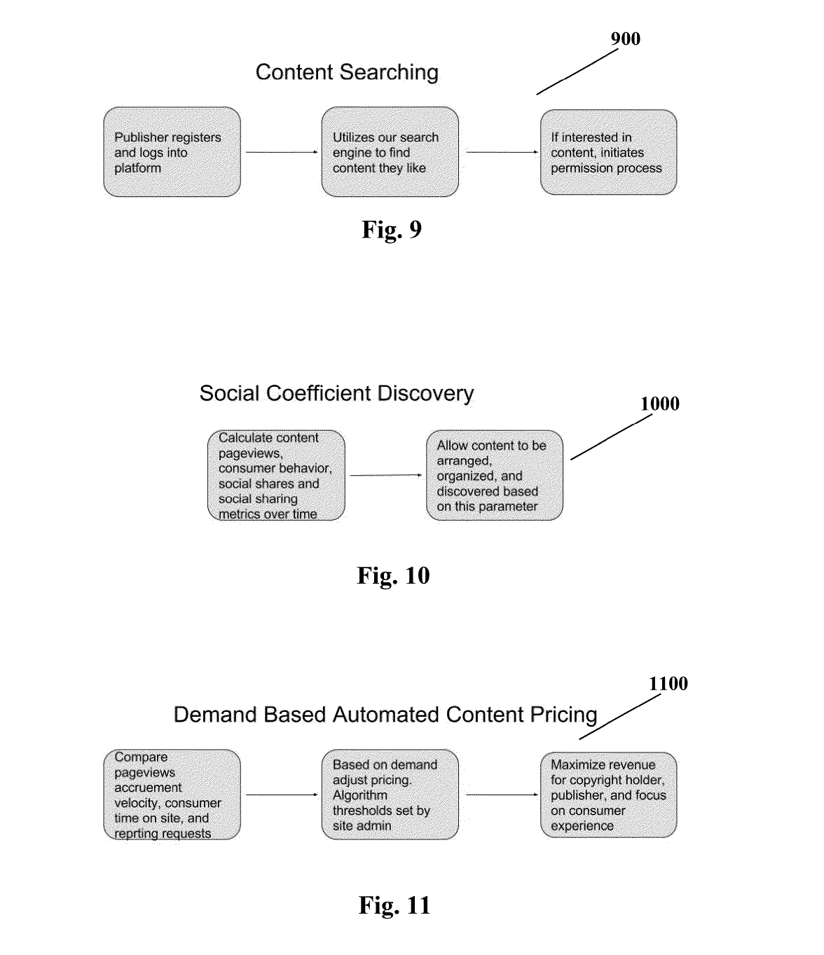

FIG. 9 provides a flow diagram of a process embodied in a content-searching module 900. A prospective republisher/content subscriber can search for content on the system by means of an internal search engine. He/she can look for content written by people of a certain profession, by category, by topic, by type of narrative, and any of several other taxonomies. Once a piece of content of interest is located, the republisher/content subscriber can simply click a button to initiate a permission process.

FIG. 10 provides a flow diagram of a process embodied in social coefficient-discovery module 1000. To give high-performing content more visibility in the system 101, it is calculated how much content-consumers are engaging with the content. This is decided by accounting for content-consumers time-on-site, how many social shares the content has garnered, how many pageviews, how many backlinks, and additional parameters set by a system administrator. These data may be assigned a weighted value to create a “Social Coefficient” in order to give the best performing content in each category more visibility. Through the aforementioned parameters (and more may be added as Admin sees fit) publishers one can discover which content is rising in performance.

Backlinks may be discovered through searching the web and calculating velocity at which backlinks are being created as well the total. Social shares may be determined by scanning a site for social networking widgets and reading the outputted value that indicates the amount of shares. Social Coefficient discovery may occur on a daily basis, but may also occur more frequently, as determined by a system administrator. Calculations may take into account the amount of time the content has been published and available. Thus, content listings may be organized and searchable by the amount of social activity, predicting the content's true performance potential. The data from ‘selected’ or ‘all reprints’ can be used to calculate the Social Coefficient.

FIG. 11 provides a flow diagram of a process embodied in a demand-based content pricing module 1100. Demand-based pricing allows flexible pricing and adjustment based on content performance, so that the listing price may be automatically adjusted, based on recent and total past performance. The listing price can be adjusted up or down based on market demand by comparing one or more of: pageviews; accruement velocity; time on site behavior and requests to reprint. Data from ‘selected’ or ‘all reprints’ can be used to automate the demand based pricing with the purpose of deriving the best value for copyright holders, republisher/content subscribers, and content consumers.

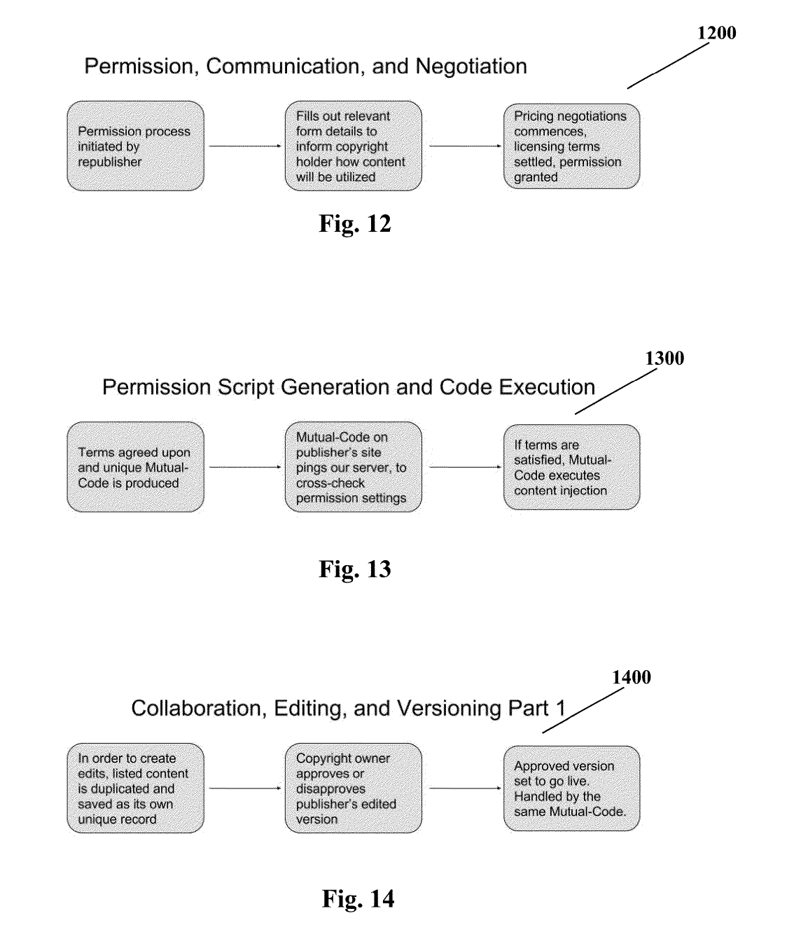

FIG. 12 provides a flow diagram of a process embodied in a permission, communication and negotiation module 1200. Permission to reprint content is requested by clicking on a button which prompts the republisher/content subscriber to list details about how they intend to use the content, the URL or device the content is to appear on, and other relevant details that might be useful to persuade the copyright holder to grant permission to reprint.

Initially the copyright holder has set pricing. During the permission request process the prospective republisher/content subscriber can submit a pricing offer via a negotiation system. This enables a copyright holder to entertain offers and if they'd like to even to make a counter-offer. This is the process where a communication portal 500 opens and a dialogue can be had surrounding more detailed licensing terms.

Using various licensing templates, the system 101 enables the negotiating parties to create legal documents from fill-in-the-blank forms. Price per pageviews, duration of the license, geographic limitations, age restrictions and many other terms can be handled in fine-grained detail during the negotiation process. Any restrictions that can be implemented and monitored by computer code, including even the blocking of individual IPs from accessing the content, can be administered by the Mutual-Code. Ultimately, the copyright holder may have the final say and determine the final negotiated terms to be approved or not.

FIG. 13 provides a flow diagram of a process embodied in a permission script generation and code-execution module 1300.

When negotiation of terms and conditions results in an agreement, the system may generate “Mutual-Code” that executes the agreed terms exactly. Mutual-Code works by receiving an initial ping from the republisher/content subscriber's site or device, cross-checking the various permissions and then determining to display the copyrighted content or not. For example, if access to content consumers in a certain geolocation is prohibited, the system 101 may scan the incoming request's IP address and, if that IP address belongs to an individual in a prohibited location, the Mutual-Code script produces a message instead of the intended content. If the duration of the license has exceeded, the Mutual-Code may ping the server 105b, which may check to see if the content is still allowed to display on the republisher/content subscriber's site. If the duration parameter indicates the license is no longer valid, the Mutual-Code ceases to display the intended content. The same process works the same for virtually all parameters set forth in the content licensing agreement. The copyright holder also has the ability to terminate and forfeit any agreements. Upon termination, the Mutual-Code will cease to execute and deliver content. This ultimately democratizes access control to content.

FIG. 14 provides a flow diagram of a process embodied in a first collaboration-editing and -versioning module 1400. Often, a publication may need potential reprints edited from their original form, in order to be suitable for the site it will exist on. In this case, the original content is duplicated once and accessible only to the copyright holder and the party that will reprint the content. The content may then be placed in its own editing area and, as edits are made, the two parties can review the changes made.

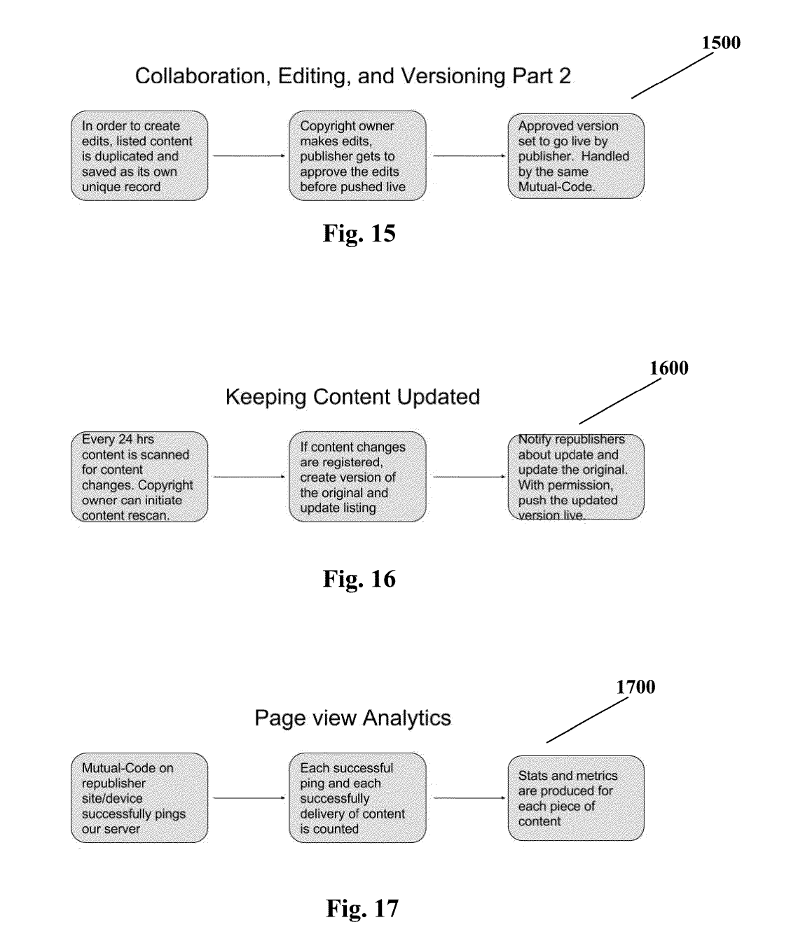

The copyright holder ultimately may grant permission for the edited version. FIG. 15 provides a flow diagram of a process embodied in a second collaboration-editing and -versioning module 1500. A republisher/content subscriber may be required to approve edits to content made by the copyright holder before any changes to the original content is reprinted because the content will ultimately appear on republisher/content subscriber's site or device. This mechanism is to ensure that content that appears on the republisher/content subscriber's property or device has been approved by the owner of the platform the content is to appear on. The system has both HTML editors and WYSIWYG (What-You-See-Is-What-You-Get) drag-and-drop content editing capabilities for articles and other compatible forms of content. As edits are made, different versions can be stored and the parties can, with each other's permission, set one of the versions live. This live version may then be set to be delivered by Mutual-Code on the republisher/content subscriber's site or device.

FIG. 16 provides a flow diagram of a process embodied in a content updating module 1600. Original content listings may be crawled at regular intervals. If changes are detected that exceed a threshold set by a system administrator, an updated version will be stored and the republisher/content subscriber may be notified of the update. Each content update or variation may be treated as a separate version. A republisher/content subscriber may be asked to accept the latest updated version. Versions may be saved and records of the changes recorded and stored. This allows the system to automate and timestamp updates and capture each change. The update may also be reviewed by platform editors and pushed live if a publisher fails to respond in a timely fashion, in order, for example, to push important updates live. Furthermore, a content owner may navigate to his/her content listing and prompt the system 101 to immediately rescan the site, if, for example, he/she made some changes and would like those changes reflected in reprints and future reprints.

FIG. 17 provides a flow diagram of a process embodied in an analytics module 1700. To determine pageviews and provide accurate analytics, the number of times Mutual-Code on the republisher/content subscriber's site or device successfully pings the server 105b (and the desired content is delivered) is counted. The system 101 records when the ping occurs and how many times it has occurred. Each Mutual-Code is specific to the copyright holder, the republisher/content subscriber, and the content to be delivered so data can be tracked and provided to relevant parties in the transaction. Statistics are produced and organized for each piece of content.

While the system may track each ping from a republisher/content subscriber's site or device, the system 101 is able to produce statistics on how the content is being used. Pageviews, or the amount of times Mutual-Code is called upon and successfully executes, enables the system to provide accurate data to the copyright holder, the entity or person republishing the content as to how pieces of content are performing. This data also enables charging on a performance basis so content can be “rented” on a pageview, time-on-site, or any other metric the Mutual-Code can generate to determine an ultimate cost to the content subscriber.

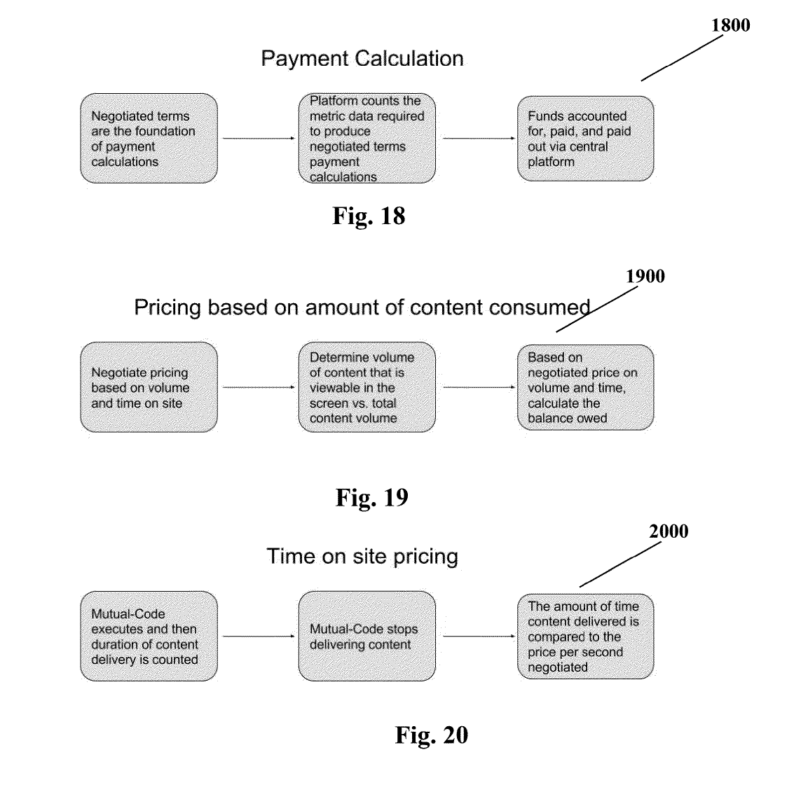

FIG. 18 provides a flow diagram of a process embodied in a payment calculation module 1800. Payments are calculated based on negotiated terms, which may be based on a flat fee, no cost, price-per-pageviews, pricing based on time-on-site, and more. Virtually any payment term negotiated by the parties are allowed as long as they can be implemented and monitored by Mutual-Code. The system acts as the accounting conduit between the negotiated parties. Payments are collected and disbursed from the central platform.

FIG. 19 provides a flow diagram of a process embodied in a time-on-site pricing module 1900. Time-on-site payments may be calculated by how long the syndicated content reprint is being viewed by an end user. This is measured by counting the amount of time between the moment Mutual-Code is initially executed and displaying the subscribed content and the time the code is no longer being utilized. A time-on-site pricing model may be on, for example a per-second, -minute, or -hour basis. If pricing is, for example, $0.01/second then if someone is browsing this content for 1 minute, the cost would be $0.60. This model is particularly useful when copyright owners would like their content displayed on publisher's sites perhaps for greater exposure and reach. The content owner would be compensating the publisher in this instance, and terms can be negotiated through the system.

Flexibly, depending on the terms negotiated, the republisher/content subscriber may also pay the copyright holder on a per time-on-site basis. The Mutual-Code collects the relevant data to compute time-on-site pricing and is able to facilitate any pricing model that is negotiated as long as the data and analytics garnered through the content distribution and consumption process permits it.

FIG. 20 provides a flow diagram of a process embodied in an amount-consumed pricing module 2000. Pricing based on content consumed is achieved by measuring the amount of time content is viewable above the fold or on the screen's primary viewable area. Pricing based on content consumed is simply a combination between time on site and the amount of page scrolling that occurs or the ratio of total content that is viewed. The thresholds and algorithm to determine the final pricing is flexibly negotiable through the system interface.

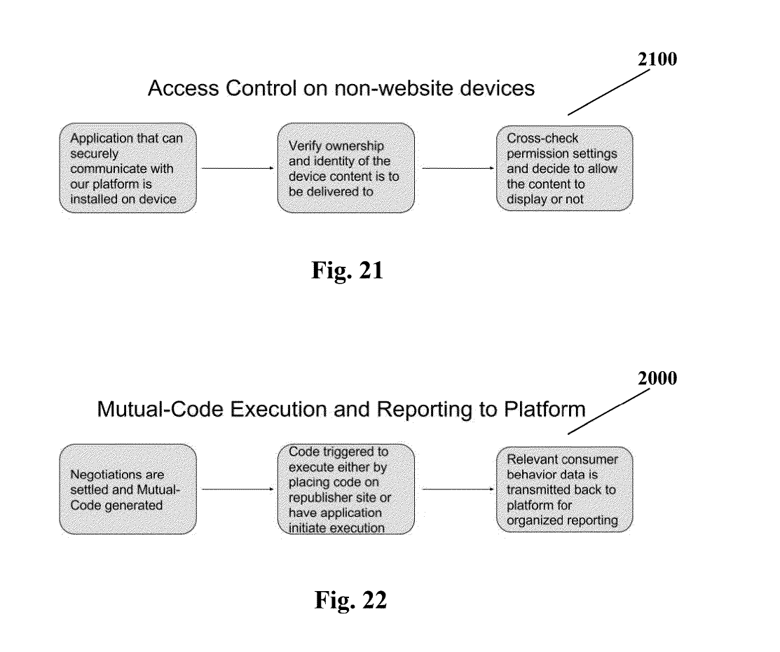

FIG. 21 provides a flow diagram of a process embodied in an access control module for non-website devices 2100. By providing compatible software applications, the system 101 may be accessible by devices such as mobile phones, tablets, entertainment systems, transportation, and more. While an application on a subscriber's device is running, the system can verify ownership of the device through a series of ownership protocols, such as by using secret keys that are generated for the person or device to determine ownership of the device the content is to be consumed on. In this way, the software application may connect directly to the system, connecting the device to the server 105b. The device will now behave as a republisher/content subscriber would if they were negotiating to reprint content on a website as opposed to a device—the end consumer asks for permission directly to the copyright holder to consume the content on his or her device in their possession, which is executed by Mutual-Code and the software application on the device the content is to be consumed on. This allows direct to consumer access control for the copyright holder.

When authentication is complete, the permission settings related to the content to be consumed are stored on the client application and will continue to operate to deliver content as long as the content is being consumed according to permission parameters set by the copyright holder. Depending on the copyright holder, content can temporarily be stored on the client app—or, if required, streamed to the device, depending on how the copyright holder would like his/her content to be handled.

In embodiments, the application may send the server 105b periodical pings in order to update and/or to verify that permission settings have not changed. This enables the content to exist on the device, even though it can only be accesses according to the licensing terms set forth by the copyright holder. Once a license expires or terminates, the application may cease to deliver the requested content and may automatically delete any digital record of the content temporarily stored on the application. Once again this step is determined by the license created between the copyright holder and the content consumer.

In the same way that a copyright holder can terminate an agreement with the content subscriber to prevent the copyright holder's content to appear on republisher/content subscriber's websites or devices, a copyright holder, through this process, can terminate access to his/her content to an identified consumer device. In the same way, usage metrics garnered from content facilitated by Mutual-Code can be used to produce pricing models for content consumers, the system 101 is able to charge the content consumer directly and perform this transaction on behalf of the copyright holder.

Certain use cases include the capability for an artist to upload an image and allow that image to only display on permitted TVs or large screens as a digital reprint. Another example of how this could be used is allowing entertainment systems, specifically Virtual Reality immersive visual and auditory capable machines, to access Virtual Reality content from the system direct from the copyright holder to the consumer. The content listing process, the permission negotiating process, and the pricing process largely remains the same.

If these devices are not connected to the Internet, the software itself, upon the next time the application is opened, may determine whether to display or to no longer display the leased or negotiated content. Alternatively, an Internet connection may be mandatory for content to be viewed and accessed—even if it is just for a moderately small ping to the server 105b. Indeed, it is necessary just to cross-check permission settings and then to communicate with the native application on the consumer's device to enable or disable content consuming.

A different client app may be needed depending the access device. Different machines may require different interfacing and software to run on the machine. For example, an app for an Apple iPhone would be different form an Android app. An application that runs on a smart TV needs to be different than an application that runs on other devices. Depending on the machine the content is to display on, different versions of an application may need to be provided to interface with the device's operating system and hardware. Nonetheless, the underlying process of requiring the application to be installed on the device, authenticate the device ownership, and then connecting with the server 105b to determine permission settings and content delivery is device agnostic. This process enables content to be available only to people and devices approved by the copyright holder.

FIG. 22 provides a flow diagram of a process embodied in a multi-code execution module 2200. After all negotiations are settled and Mutual-Code is generated, the Mutual-Code may execute based on negotiated terms. Mutual-Code may transmit back relevant data regarding a consumer's behavior with content to the server 105b. Payments and analytics for each piece of syndicated live content are recorded and made available to the copyright holder, republisher/content subscriber, and the system 101. In the event that during the cross-checking of permission settings, all licensing permissions are not passed, the Mutual-code will fail to execute.

Mutual-Code may execute only if the circumstances and permission parameters of the ping to the server 105b adequately pass the permission settings. The system 101 checks for whether or not the content is allowed to be delivered to website or device that is initiating the original ping. If it passes the permission parameters set by the copyright holder and the republisher/content subscriber, Mutual-Code will initiate an injection process to provide access to the subscribed content. If permission parameters are not met, the Mutual-Code will not initiate the content delivery process. Analytics are determined based on the number of successful pings to our server and successfully delivered content. Payments and costs for the content “rental” are determined based on the agreements set forth between the copyright holder and the subscribing party, and counted based on analytic data retrieved from Mutual-Code.

In embodiments, the system may be configured as any of a licensing tool, a content management tool, a content collaboration tool, as an application that provides tools for simplifying complex processes useful for publishing, content syndication, and content management.

In embodiments, the system may be configured to control access to digital video files, for by monitor the number of times that videos are allowed to be played by a certain user or device; or by enforcing a time period for which the video may be accessed; or by controlling from which domain(s) the video may be accessed.

In embodiments, the system can be configured to allow a high definition image to be licensed and put on display only to a few certain paying patrons. Additionally, the system may manage the payment and terms required to facilitate delivery of content in a controlled manner. In embodiments, the system can be configured as a place where links can be paid for, where publishers can pay republisher/content subscribers to share their content, and as a place where ads can be displayed.

In embodiments, the system can be a place where any copyright holder may store his/her content publicly or privately and may have full control of where he/she would like the content to display and how it should display.

In embodiments, the system can be used in corporate settings to manage and update network wide documentation and content.

In embodiments, the system can be used for copyright holders to connect directly with content consumers to negotiate terms and licenses and have the licensed content be delivered in a manner that is trackable, retractable, and portable.

In embodiments, the system can also enable the delivery of content to devices and other electronic apparatus, such as autonomous vehicles, that have an internet connection, computing power, and an interface and bridge to the system.

In embodiments, the system can be used in the medical field to permit access control of private, personal information by the content's owner to medical systems such as electronic health records.

In embodiments, the system can particularly be useful in allowing content creators, particularly video and virtual reality content creators, to produce and distribute their creations directly to a content consumer or to a consumer device, delivering the content, tracking its consumption and handling access control and payment compensation.

As will be understood by those familiar with the art, the methods and system herein described may be embodied in other specific forms without departing from the spirit or essential characteristics thereof. Additionally, the methods and systems may be embodied in a computer program product that includes computer-readable code provided on a non-transitory computer-readable medium. A non-transitory medium does not include ephemeral media such as signals and carrier waves.

Likewise, the particular naming and division of the portions, modules, agents, managers, components, functions, procedures, actions, layers, features, attributes, methodologies, data structures and other aspects are not mandatory or significant, and the mechanisms that implement the systems and methods or their features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated. The specification and drawings are, accordingly, to be regarded in an illustrative sense rather than a restrictive sense.

1. A computer-implemented method for controlling access to digital content comprising:
receiving, by a processor on a first computing device within a network, data representing conditions for access to at least one item of digital content, the conditions for access having been negotiated online between an owner of the at least one item of digital content and a republisher/content subscriber;
evaluating, by the processor, the data representing the conditions for access to at the least one item of digital content;
responsive to said evaluating, producing, by the processor, data representing computer-readable instructions for implementing and monitoring the conditions for access to at the least one item of digital content;
the processor transmitting the data representing computer-readable instructions for implementing and monitoring the conditions for access to at the least one item of digital content to a second computing device on the network, the second computing device being under the control of the republisher/content subscriber;
receiving at the first computing device data representing a request to access the least one item of digital content, the request being transmitted by the second computing device;
responsive to receipt of data representing a request to access the at least one item of digital content, the first computing device transmitting data representing the at least one item of digital content to the second computing device;
the second computing device displaying the at least one item of digital content according the conditions for access.

2. The method of claim 1, wherein a third computing device on the network is under control of the owner of the at least one item of digital content.

3. The method of claim 2, further comprising:
storing the at least one item of digital content at the third computing device;
the third computing device transmitting to the first computing device data representing a request to list the at least one item of digital content as being available for licensing;
the first computing device, responsive to receipt and evaluation of the data representing the request to list the at least one item of published digital content as being available for licensing, transmitting to the third computing device data representing at least one content tag for identifying said at least one item of digital content;
responsive to receipt of the data representing at least one content tag for identifying the at least one item of digital content, the third computing device inserting the at least one content tag into a data file containing the at least one item of digital content to identify it; and
the third computing device transmitting data representing a notice to the first computing device that the at least one content tag has been placed to identify the at least one item of digital content.

4. The method of claim 2, further comprising:
responsive to receiving and evaluating data representing a notice that at least one content tag has been placed to identify the at least one item of digital content, the first computing device scanning the at least one item of digital content for similarity to other items of digital content listed on the first computing device;
responsive to a determination that the at least one item of digital content exceeds a permissible threshold of similarity to other items of digital content listed on the first computing device, rejecting the at least one item of digital content for listing;
responsive to a determination that the at least one item of digital content does not exceed a permissible threshold of similarity to other items of digital content listed on the first computing device, accepting the at least one item of digital content for listing;
responsive to accepting the at least one item of digital content for listing, the first computing device creating an instance of the at least one item of digital content for distribution to republisher/content subscribers; and
storing the instance of the at least one item of digital content in a content repository at the first computing device.

5. The method of claim 1, wherein negotiating the conditions of access online between an owner of the at least one item of digital content and a republisher/content subscriber of the at least one item of digital content comprises:
the second computing device transmitting data representing an offer to license the at least one item of digital content to a third computing device under control of the owner.

6. The method of claim 5, wherein negotiating the conditions of access online between an owner of the at least one item of digital content and a republisher/content subscriber of the at least one item of digital content comprises:
the third computing device transmitting data representing an acceptance of an offer to license the at least one item of digital content to the second computing device.

7. The method of claim 1, wherein a communication portal allows exchange of data representing any of: offers, acceptances and counters during a negotiation between a content owner and a republisher/content subscriber.

8. The method of claim 1, further comprising providing a content search function whereby a republished identifies the at least one item of digital content as a target for licensing.

9. The method of claim 1, further comprising:
the processor identifying high-performing content by calculating a social coefficient for any item of digital content.

10. The method of claim 1, further comprising:
the processor calculating pricing for any item of digital content based on content consumer demand, as indicated by at least one of:
number of pageviews;
accruement velocity;
time on site behavior; and
requests to reprint.

11. The method of claim 1, wherein conditions for access include at least one of:
price per a predetermined number of pageviews;
license duration;
geographic limitations;
age restrictions.

12. The method of claim 1, further comprising:
the processor generating program code that executes the conditions for access;
responsive to receiving a content request from the second computer, evaluating the conditions for access;
the processor either determining to display the at least one item of digital content or not to display the at least one item of digital content responsive to said evaluating the conditions for access; and
responsive to a request from the content owner to terminate a license, the processor ceasing to execute and deliver content.

13. The method of claim 1, further comprising:
the processor adapting appearance of the at least one item of digital content to be suitable for presentation at said second computing device; and
the processor displaying proposed edits to said republisher/content subscriber via said second computing device to secure approval before the proposed edits are made.

14. The method of claim 1, further comprising at least one of:
the processor monitoring updates to any item of digital content;
responsive to updates exceeding a permissible threshold, the processor issuing an update to the updated item of digital content;
the processor issuing notification of the update; and
the processor monitoring and saving an update history.

15. The method of claim 1, further comprising:
the processor maintaining a log of access requests and accesses for each item of digital content.

16. The method of claim 1, further comprising:
the processor calculating payments according to negotiated terms.

17. The method of claim 16, wherein the negotiated terms comprise any of:
flat fee;
no cost;
price for a predetermined number of pageviews; and
time on site, calculated by amount of time content is being viewed by an end user.

18. The method of claim 1, further comprising:
the processor providing access to an end-user device through a client application resident on the end-user device, wherein the client application is individualized according to device type;
the processor verifying ownership of a device by evaluating at least one key installed on the device by the application;
the processor evaluating conditions for access to the at least one item of digital content stored on the device by the client applications;
granting access to the at least one item of digital content according to the stored conditions; and
the processor monitoring consumer use of listed digital content via data stored on the end-user device by the client application.

19. A computer program product comprising at least one non-transitory computer-readable storage medium, the at least one non-transitory computer readable medium storing program code that, when loaded into computer memory and executed by a processor performs:
receiving, at a first computing device within a network, data representing conditions for access to at least one item of digital content, the conditions for access having been negotiated online between an owner of the at least one item of digital content and a republisher/content subscriber of the at least one item of digital content;
evaluating the data representing the conditions for access to at the least one item of digital content;
responsive to said evaluating, producing data representing computer-readable instructions for implementing and monitoring the conditions for access to at the least one item of digital content;
transmitting the data representing computer-readable instructions for implementing and monitoring the conditions for access to at the least one item of digital content to a second computing device on the network, the second computing device being under the control of the republisher/content subscriber;
receiving at the first computing device data representing a request to access the least one item of digital content, the request being transmitted by the second computing device;
responsive to receipt of data representing a request to access the at least one item of digital content, the first computing device transmitting data representing the at least one item of digital content to the second computing device; and
displaying at the second computing device, the at least one item of digital content according the conditions for access.

20. A computer system for policy-based confidentiality management comprising:
computer memory;
at least one processor;
program code residing in the computer memory for:
receiving, at a first computing device within a network, data representing conditions for access to at least one item of digital content, the conditions for access having been negotiated online between an owner of the at least one item of digital content and a republisher/content subscriber of the at least one item of digital content;
evaluating the data representing the conditions for access to at the least one item of digital content;
responsive to said evaluating, producing data representing computer-readable instructions for implementing and monitoring the conditions for access to at the least one item of digital content;
transmitting the data representing computer-readable instructions for implementing and monitoring the conditions for access to at the least one item of digital content to a second computing device on the network, the second computing device being under the control of the republisher/content subscriber;
receiving at the first computing device data representing a request to access the least one item of digital content, the request being transmitted by the second computing device;
responsive to receipt of data representing a request to access the at least one item of digital content, the first computing device transmitting data representing the at least one item of digital content to the second computing device; and
displaying at the second computing device, the at least one item of digital content according to the conditions for access.
